(19) United States
(12) Patent Application Publication
(10) Pub. No.: US 2022/0288663 A1
(43) Pub. Date: Sep. 15, 2022

(54) BENDING METHOD AND BENDING SYSTEM

(71) Applicant: AMADA CO., LTD., Kanagawa (JP)

(72) Inventors: Hirohito NAGAHASHI, Kanagawa (JP); Kazunari IMAI, Kanagawa (JP); Satoru UESUGI, Kanagawa (JP)

(21) Appl. No.: 17/639,738

(22) PCT Filed: Sep. 14, 2020
(86) PCT No.: PCT/JP2020/034781

§ 371 Date: Mar. 2, 2022

(30) Foreign Application Priority Data
Sep. 17, 2019 (JP) 2019-168151

(51) Int. Cl. B21D 5/00

(52) U.S. Cl. CPC B21D 5/004

(57) ABSTRACT

A bending method is a method for bending a workpiece by a bending system including a bending machine equipped with tools including a punch and a die provided so as to be relatively movable, a manipulator configured to position the workpiece with respect to the tools, and a control device configured to control the bending machine and the manipulator to perform bending, the method including resetting, during an automatic operation of the bending of the workpiece by the bending machine, a pushing amount of the punch with respect to the die or an original position of the punch for each predetermined trigger condition.

### TECHNICAL FIELD

The present invention relates to a bending method and a bending system for bending a workpiece.

### BACKGROUND ART

There is known a bending machine in which an approximate expression of a bending load is obtained based on an initial bending load and a relative moving position of a punch with respect to a die so that bending can be performed with higher accuracy than before when a workpiece is bent by the bending machine (see, for example, Patent Literature 1 described below).

In this bending machine, the moving position when the bending load is zero according to the approximate expression is set as a so-called pinch point at which the punch is in contact with the workpiece. Therefore, the bending machine is said to achieve bending with higher accuracy by setting the pinch point near the rise of the bending load. In other words, a change in a bending angle due to displacement of a frame associated with secular change of the bending machine is corrected by obtaining this approximate expression every time the bending is performed, for every predetermined number of times of bending, for every arbitrary number of times of bending, or the like.

### CITATION LIST

### Patent Literature

Patent Literature 1: Japanese Patent Application Laid-Open Publication No. 2006-88183

### SUMMARY

### Technical Problem

However, when bending is performed, for example, by an automatic operation with the conventional bending machine disclosed in the above Patent Literature 1 in order to correct the change in the bending angle due to secular change as described above, processing of obtaining the approximate expression needs to be performed for every predetermined times of bending or the like. This requires the correction to be made while the movement of the punch of the bending machine is temporarily stopped. Therefore, there is a problem in that the machine operation is stopped every time the correction is made, resulting in an extended tact time and cycle time that may lower productivity.

The present invention has been made in view of the above circumstances, and it is an object of the present invention to provide a bending method and a bending system capable of not only correcting, without stopping an operation, a change in a bending angle due to secular change of the bending system that is automatically operated, but also improving productivity and quality.

### Solution to Problem

A bending method according to the present invention is a method for bending a workpiece by a bending system including a bending machine equipped with tools including a punch and a die provided so as to be relatively movable, a manipulator configured to position the workpiece with respect to the tools, and a control device configured to control the bending machine and the manipulator to perform bending, the method including resetting, during an automatic operation of the bending of the workpiece by the bending machine, a pushing amount of the punch with respect to the die or an original position of the punch for each predetermined trigger condition.

In one embodiment of the present invention, the trigger condition is at least one of a room temperature, a time, and the number of processes.

In another embodiment of the present invention, the resetting is executed when a resetting condition is satisfied after the trigger condition is satisfied.

In still another embodiment of the present invention, the resetting condition is that the workpiece is being loaded or unloaded by the manipulator.

In still another embodiment of the present invention, setting ON/OFF of execution of the resetting by the control device is included.

In still another embodiment of the present invention, the pushing amount is reset in the resetting based on a tool original position on a D-axis when a predetermined load is applied to the tools.

In still another embodiment of the present invention, calculating a secular change amount of the tool original position as a correction value for the pushing amount is included, in which the pushing amount is corrected by using the calculated correction value during the automatic operation to bend the workpiece.

In still another embodiment of the present invention, the original position of the punch is reset in the resetting based on a D-axis position when the workpiece is interposed between the tools.

A bending system according to the present invention is a bending system including a bending machine equipped with tools including a punch and a die provided so as to be relatively movable, a manipulator configured to position a workpiece with respect to the tools, and a control device configured to control the bending machine and the manipulator to perform bending, in which the control device resets, during an automatic operation of the bending of the workpiece by the bending machine, a pushing amount of the punch with respect to the die or an original position of the punch for each predetermined trigger condition to perform the bending.

In one embodiment of the present invention, the trigger condition is at least one of a room temperature, a time, and the number of processes.

In another embodiment of the present invention, the pushing amount or the original position of the punch is reset when a resetting condition is satisfied after the trigger condition is satisfied.

In still another embodiment of the present invention, the resetting condition is that the workpiece is being loaded or unloaded by the manipulator.

In still another embodiment of the present invention, the control device sets ON/OFF for resetting the pushing amount or the original position of the punch.

In still another embodiment of the present invention, the pushing amount is reset based on a tool original position on a D-axis when a predetermined load is applied to the tools.

In still another embodiment of the present invention, the control device calculates a secular change amount of the tool original position as a correction value for the pushing amount, and corrects the pushing amount by using the calculated correction value during the automatic operation to bend the workpiece.

In still another embodiment of the present invention, the original position of the punch is reset based on a D-axis position when the workpiece is interposed between the tools.

### Advantageous Effects of Invention

According to the present invention, a change in a bending angle due to secular change can be corrected without stopping an operation. At the same time, productivity and quality can be improved.

### BRIEF DESCRIPTION OF DRAWINGS

FIG. 1 is a diagram showing a schematic entire structure of a bending system that executes a bending method according to a first embodiment of the present invention.

FIG. 2 is a diagram showing an outline of typical tools used for a press brake of the bending system.

FIG. 3 is a block diagram showing a schematic internal structure of a control device of the bending system.

FIG. 4 is a flowchart showing an outline of processing procedures of the bending method executed by the bending system.

FIG. 5 is a diagram showing an outline of typical tools used for a press brake of a bending system according to a second embodiment of the present invention.

### DESCRIPTION OF EMBODIMENTS

Hereinafter, the bending method and the bending system according to the embodiments of the present invention will be described in detail with reference to the attached drawings. However, the following embodiments do not limit the invention according to each claim, and not all combinations of features described in the embodiments are essential for the solution of the invention.

### First Embodiment

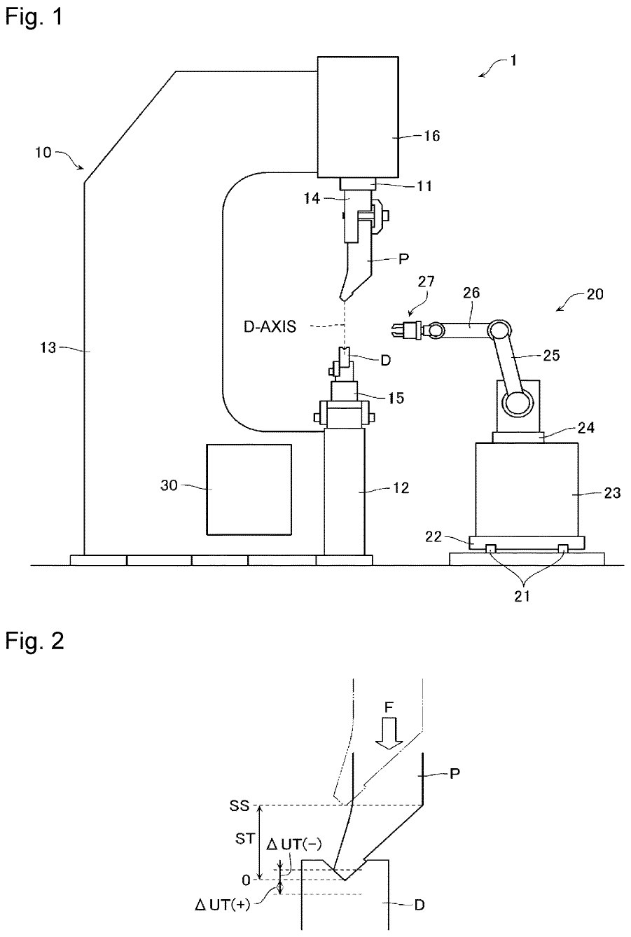

FIG. 1 is a diagram showing a schematic entire structure of a bending system that executes a bending method according to a first embodiment of the present invention. FIG. 2 is a diagram showing an outline of typical tools used for a press brake of the bending system. As shown in FIG. 1, a bending system 1 includes a press brake 10 that is a bending machine, an automatic robot 20 that is a manipulator configured to position a workpiece with respect to the tools of the press brake 10, and a control device 30 configured to control the press brake 10 and the automatic robot 20 to bend the workpiece.

It should be noted that since the basic structures of the press brake 10 and the automatic robot 20 are known, only the outlines thereof will be described here. Further, in the following descriptions, the “X-axis direction” means the left-right direction when the front of the press brake 10 is faced, and the “Y-axis direction” means the depth direction in that case, and the “Z-axis direction” means the vertical direction in that case.

The press brake 10 of the bending system 1 includes an upper table 11 and a lower table 12 arranged in line in the center of the front surface vertically (in the Z-axis direction) such that each of surfaces on one side in the depth direction (the Y-axis direction), for example, each of plate surfaces on the outside faces a front surface. Further, the press brake 10 supports the tables 11 and 12, and includes support units 13 arranged on the left and right sides.

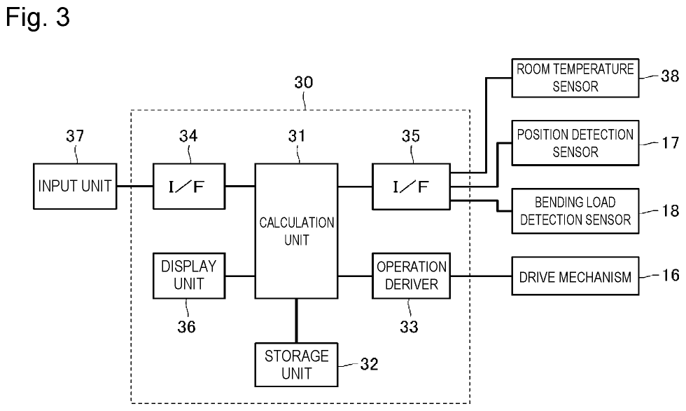

Furthermore, in the present embodiment, the press brake 10 includes a drive mechanism 16 configured to, for example, reciprocate the upper table 11 vertically with respect to the lower table 12. Additionally, the press brake 10 includes a position detection sensor 17 (see FIG. 3) configured to detect a moving position when the upper table 11 is moved by the drive mechanism 16.

The upper table 11 is made of a plate-shaped member such as a metal, for example, and includes a plurality of upper tool holders 14 for holding an upper tool such as a punch P at the lower portion thereof. The lower table 12 is made of a plate-shaped member such as a metal similar to the upper table 11, and includes lower tool holder 15 for holding a lower tool such as a die D at the upper portion thereof. In the present embodiment, each support unit 13 is composed of a plate-shaped side frame formed in a substantially channel shape in a lateral view, for example, but the support unit 13 is not limited to this. The support unit 13 may be composed of a rod-shaped tie bar or the like.

The drive mechanism 16 is, for example, a hydraulic cylinder that serves as a drive source for the upper table 11, and is each attached to the upper part of each of the support unit 13. Each of the drive mechanism 16 is configured to relatively reciprocate (move up and down) the upper table 11 vertically with respect to the lower table 12. It should be noted that each of the drive mechanism 16 can use another drive means such as a servo motor, in place of the hydraulic cylinder.

The position detection sensor 17 detects a relative moving position of the punch P with respect to the die D when the upper table 11 is moved by the drive mechanism 16. Since the position detection sensor 17 is composed of, for example, an encoder, a linear scale, or the like and thus is publicly known, detailed description thereof will be omitted here.

The position detection sensor 17 can detect a pushing amount (a moving stroke amount) (mm) that represents an inter-blade distance on a D-axis of the tools by the punch P and the die D. In the present example, as shown in FIG. 2, the pushing amount represents a distance from a reference position to an stroke start (SS) position (so-called inter-blade distance) when the position at which the punch P and the die D are engaged with each other without a workpiece is defined as the tool reference position (0 mm) and when the position of the distal end (lower end) of the punch P at a predetermined position in the direction in which the punch P is separated from the reference position is defined as the SS position, for example. It should be noted that in the first embodiment, the value of the D-axis when a predetermined load F (for example, 1 t) is applied to this reference position is read, and a secular change amount of each tool is calculated based on the read value. Then, the calculated secular change amount is used as a correction value for the pushing amount of the punch P, and the pushing amount is corrected, for example, by adding the correction value to the pushing amount.

It should be noted that the press brake 10 further includes a bending load detection sensor 18 (see FIG. 3) for detecting a bending load applied to the punch P when the upper table 11 is moved by the drive mechanism 16 to engage the punch P and the die D to bend the workpiece. The bending load detection sensor 18 can be configured to detect a fluid pressure when the drive mechanism 16 is composed of a hydraulic cylinder as described above, and can be configured to detect a torque and a load current when the drive mechanism 16 is composed of a motor, for example. In addition, as the bending load detection sensor 18, various structures such as a piezoelectric element arranged on a mounting portion of the punch P with respect to the upper table 11 (or a mounting portion of the die D with respect to the lower table 12) can be adopted.

The automatic robot 20 includes, for example, a slider 22 that can move in the left-right direction along a guide rail 21 extending in the left-right direction (X-axis direction), and includes a base frame 23 mounted on the slider 22. Further, the automatic robot 20 includes a rotation base 24 that is arranged on the base frame 23 and can turn in the horizontal direction. The rotation base 24 is provided with a first arm 25, which can swing (rotate) up and down, around a horizontally extending rotation shaft. Further, a second arm 26 rotatably arranged around a horizontally extending rotation shaft is provided on the distal-end side of the first arm 25.

Further, a robot hand 27, which is rotatable around a horizontally extending rotation shaft and rotatable around a rotation shaft in the direction orthogonal to the longitudinal direction of the second arm 26, is provided on the distal-end side of the second arm 26. The automatic robot 20 carries in and supplies the workpiece for the press brake 10 between the punch P and the die D (that is, between the tools), and discharges and carries out the bent workpiece from the press brake 10. In the bending system 1 of the present embodiment, by causing the press brake 10 and the automatic robot 20 to cooperate with each other under the control of the control device 30, for example, bending of a predetermined number of lots can be performed by an automatic operation.

FIG. 3 is a block diagram showing a schematic internal structure of the control device 30 of the bending system 1.

As shown in FIG. 3, the control device 30 includes a calculation unit 31 including a CPU, for example, a storage unit 32 including a RAM, a ROM, and the like, an operation driver 33 for operating the drive mechanism 16, an input interface (I/F) 34, a communication interface (I/F) 35, and a display unit 36 for displaying, on a display means such as a display, various types of screens such as a setting screen. Since the structure of each part of the control device 30 is publicly known, detailed description thereof will be omitted. It should be noted that a room temperature sensor 38 (see FIG. 3) for measuring a room temperature, such as a thermocouple, is electrically connected to the communication I/F 35 together with the position detection sensor 17 and the bending load detection sensor 18 described above. Further, the display unit 36 can be composed of a touch panel having a function of an input unit 37.

In the control device 30, the calculation unit 31 executes a bending program stored in the storage unit 32, and the operation of the drive mechanism 16 of the press brake 10 is controlled via the operation driver 33 under the control of this program. Further, the control device 30 can also control an operation of the automatic robot 20 via the operation driver 33 in the same manner.

It should be noted that the calculation unit 31 executes various types of arithmetic processing related to the bending based on processing conditions such as a thickness, a material, a bending angle, and a tool condition of the workpiece that are input via the input unit 37 such as a keyboard or mouse and the input I/F 34, for example. Further, the calculation unit 31 also calculates a pushing amount of the punch P from the SS position to the reference position with respect to the die D, a contact position at which the punch P contacts the workpiece, a relative pushing amount from the contact position for bending the workpiece at a desired bending angle, and the like.

The control device 30 can determine ON/OFF of a reset function for the pushing amount of the punch P with respect to the die D, for example, based on the input information input via the input unit 37. For example, when the number of lots for bending is large, an operator can arbitrarily enable (ON) the reset function for the pushing amount so that the change in the bending angle due to secular change can be automatically corrected. Further, when the number of lots for bending is small, the operator can arbitrarily disable (OFF) the reset function for the pushing amount so that the automatic operation can be performed without setting a trigger condition and the like.

Further, the control device 30 can determine whether or not an acquisition condition for setting an initial reference position and the resetting condition for resetting the pushing amount are satisfied. The control device 30 determines that the workpiece is being loaded or unloaded by the automatic robot 20, which is an example of a case in which the acquisition condition and the resetting condition are satisfied. When the reset function is enabled, the control device 30 waits until the acquisition condition and the resetting condition are satisfied. When the acquisition condition is satisfied, the control device 30 acquires the value of the D-axis as the reference position. When the resetting condition is satisfied, the control device 30 calculates the secular change amount as a correction value, and resets the pushing amount of the punch P after correcting the pushing amount by, for example, adding the correction value to the pushing amount.

The control device 30 of the bending system 1 of the present embodiment executes resetting in which the above-mentioned pushing amount is reset for each predetermined trigger condition during the automatic operation of the bending of the workpiece by the press brake 10. More specifically, at the start of the automatic operation of the bending, the initial reference position is acquired to set the pushing amount, and thereafter, the secular change amount of the reference position is calculated for each predetermined trigger condition to correct the pushing amount.

As a result, for example, by comparing the reference position acquired later with the reference position initially acquired, the secular change amount of the entire mechanical system including the tools and the drive mechanism 16 due to external factors such as a room temperature is calculated. Then, by using the calculated secular change amount as a correction value for the pushing amount of the punch P related to the bending angle (that is, a correction value for the processing conditions), it is possible to perform correction, such as adding or subtracting the correction value to or from the pushing amount, which allows the automatic operation of the bending to continue until the end of the operation. Therefore, the change in the bending angle due to secular change can be corrected without stopping the operation of the bending. As a result, productivity and quality of the bent product can be improved.

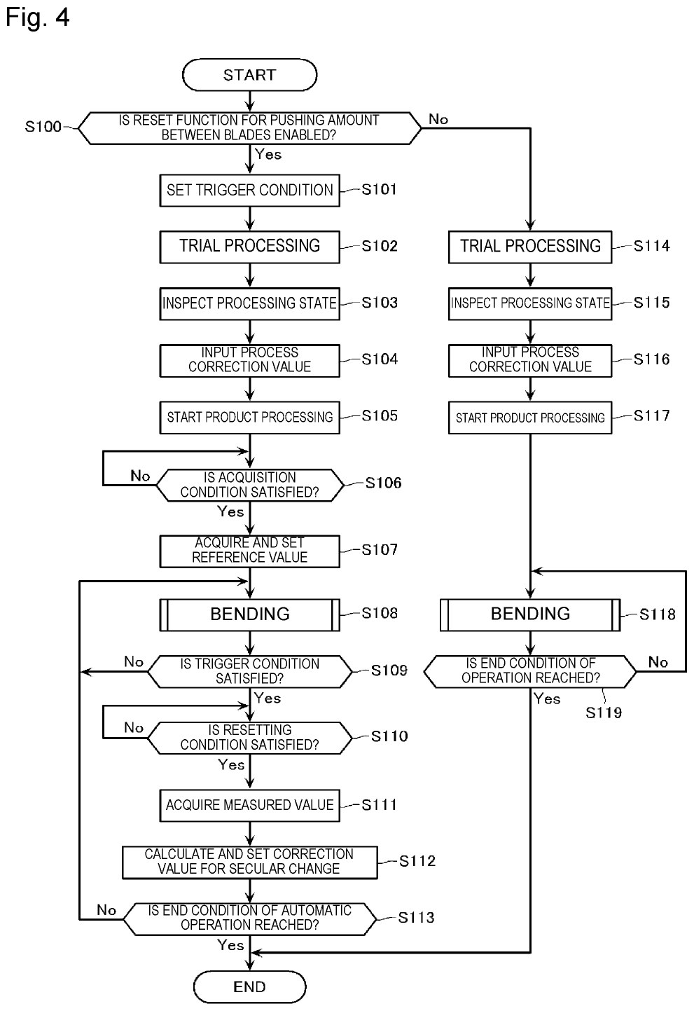

FIG. 4 is a flowchart showing an outline of processing procedures of the bending method executed by the bending system 1.

As shown in FIG. 4, the control device 30 first determines whether or not the reset function for the pushing amount of the tool is enabled (ON) by an operation input by a user via the input unit 37 and the input I/F 34, or via a touch panel of the display unit 36, or a setting input from another external PC or the like (hereinafter referred to as “input information”) after activating the bending program that the calculation unit 31 has read from the storage unit 32 (step S100).

In other words, in the step S100, ON/OFF of the reset function is determined based on the input information. For example, as described above, when the number of lots for bending is small, the operator can arbitrarily disable the reset function for the pushing amount so that the automatic operation can be performed while skipping setting processing of the trigger condition described later.

In this step S100, when it is determined that the reset function for the pushing amount is enabled (ON) (Yes in step S100), that is, when the resetting is executed, the trigger condition for resetting the pushing amount based on the input information (for executing the resetting) is set (step S101). As the trigger condition, for example, at least one of a time, a room temperature, and the number of processes is set.

Here, if the trigger condition to be set is the time, for example, the condition of the time such as every hour or every two hours from the start of the automatic operation is set.

Further if the trigger condition to be set is the room temperature, for example, the condition of the room temperature is set such as using a room temperature at the start of the automatic operation as a reference value and then incrementing/decrementing the temperature change by ±10% from the reference value, or repeating setting, as the next reference value, a value of a temperature increased or decreased in an absolute temperature from the room temperature set as the reference value.

Furthermore, if the trigger condition to be set is the number of processes, for example, the condition of the number of lots of the process such as every 50 lots or every 100 lots from the start of the automatic operation is set.

In addition, for example, if the tool needs to be replaced between steps, the case may be set as the trigger condition in which it is detected that the same tool has been installed as a result of the tool replacement. Hereinafter, it is assumed that the room temperature is used as the trigger condition to be set, and the pushing amount is reset using the case as a trigger in which a predetermined temperature change is incremented/decremented from a room temperature at the start of the automatic operation.

After setting the trigger conditions in this manner, the press brake 10 and the automatic robot 20 are operated to perform trial processing (check operation) of the workpiece (step S102), and the processing state is inspected by measuring the bending angle and various dimensions (Step S103). After that, a correction value (process correction value), which is related to the bending angle, various dimensions, the pushing amount of the punch P, and the like with respect to the processing conditions that have been set, is calculated. Then, the process correction value is set by being input based on the input information (step S104), the temperature is measured by the room temperature sensor 38, and an operation of product processing is started (step S105).

When the processing operation is started, it is first determined whether or not the acquisition condition of the reference value for setting the initial pushing amount is satisfied (step S106). In the present embodiment, this acquisition condition indicates that the workpiece is being loaded by the automatic robot 20. Therefore, the control device 30 waits until the acquisition condition is satisfied (for example, until the workpiece is being loaded for the first time) (No in step S106). When the acquisition condition is satisfied (when the workpiece is being loaded) (Yes in step S106), the control device 30 acquires a value of the initial reference position (a reference value UT0) to set the tool condition (step S107).

It should be noted that if the acquired reference value UT0 is stored, for example, in the storage unit 32, the tool condition can be set by using this reference value UT0 when a product is processed across days by using the same tool. As a result, it is not necessary to acquire the reference value UT0 again. Then, the bending processing of the workpiece (step S108) is automatically executed under the processing conditions including the tool condition that has been set.

During the automatic operation of the bending processing, it is determined whether or not the trigger condition is satisfied (the trigger condition is reached) based on the room temperature measured by the room temperature sensor 38, that is, whether or not a predetermined temperature change from the room temperature at the start of the automatic operation has been incremented/decremented (step S109). When it is determined that the predetermined temperature change has not been incremented/decremented from the room temperature at the start of the automatic operation and thus the trigger condition is not satisfied (No in step S109), the bending processing in step S108 is continued.

On the other hand, if it is determined that the predetermined temperature change has been incremented/decremented from the room temperature at the start of the automatic operation and the trigger condition is satisfied (Yes in step S109), it is determined whether or not the resetting condition for resetting the next pushing amount is satisfied (step S110). In other words, as described above, the control device 30 waits until the resetting condition is satisfied (No in step S110). When the resetting condition is satisfied (Yes in step S110), the control device 30 acquires a value of the next reference position (a measured value UT1) (step S111).

When the measured value UT1 acquired in this manner is compared with the reference value UT0 initially acquired, a displacement value ΔUT (a displacement between the measured value UT1 and the reference value UT0) at the reference position can be calculated as shown in FIG. 2. When the reference position is set to 0, the displacement value ΔUT can be positive in the direction toward the die D and negative in the direction away from the die D when viewed from a movement stroke of the punch P on the D-axis, for example. Then, a correction value (a secular change amount) ΔUT1 of the initial secular change from the reference position is calculated based on the displacement value ΔUT, and the pushing amount is corrected by adding the correction value ΔUT1 to, for example, the initial pushing amount to set the tool condition (step S112). It should be noted that the correction of the pushing amount is not limited to the addition of the correction value ΔUT1.

After setting the tool condition, it is determined whether or not an end condition of the automatic operation, for example, whether or not a preset number of process lots of the workpiece (200 lots, or the like) has been reached (step S113). If it is determined that the end condition has not been reached (No in step S113), the automatic operation of the bending processing of the workpiece (step S108) is continued based on the processing conditions including the tool condition set in step S112. On the other hand, if it is determined that the end condition has been reached (Yes in step S113), the automatic operation is ended and the processing of the bending method according to the present embodiment is ended.

If the automatic operation of the bending processing is continued in step S108 described above, it is determined whether or not the trigger condition is satisfied during the automatic operation, for example, whether or not a predetermined temperature change has been incremented/decremented from the previously incremented/decremented room temperature (step S109). If the predetermined temperature change has not been incremented/decremented, the bending processing is continued as it is because it is considered that the trigger condition is not satisfied (No in step S109). However, if there is a predetermined temperature change, it is considered that the trigger condition is satisfied (Yes in step S109) and it is determined whether or not the resetting condition for the next resetting is satisfied (step S110).

Also at this point, as described above, the control device 30 waits until the resetting condition is satisfied (No in step S110). When the resetting condition is satisfied (Yes in step S110), the control device 30 acquires a value of the next reference position (a measured value UT2) (step S111). Then, the measured value UT2 is compared with the initial reference value UT0 to calculate a displacement value ΔUT (a displacement between the measured value UT2 and the reference value UT0) of the reference position, and a correction value (secular change amount) ΔUT2 of the second secular change from the reference position is calculated. The pushing amount is corrected by this correction value ΔUT2, for example, by adding the correction value ΔUT2 to the initial pushing amount as described above to set the tool condition (step S112). Thereafter, the next determination processing (step S113) is executed, and the subsequent processing is repeated.

In this manner, the bending system 1 of the present embodiment can repeat the acquisition of the value of the reference position a plurality of times (for example, n times) until the end condition of the automatic operation is reached, for example, at a stage at which the resetting condition is satisfied every time the trigger condition is satisfied. As a result, it is possible to calculate a displacement value ΔUT associated with secular change of the tools and the mechanical system by comparing the reference value UT0 of the reference position initially acquired with the measured values UT1 to UTn of the reference position acquired for the first to nth acquisitions, and then to calculate the correction values ΔUT1 to ΔUTn of the first to nth secular changes. Then, after correcting the pushing amount by using the correction values ΔUT1 to ΔUTn, for example, by adding the respective correction values ΔUT1 to ΔUTn to the pushing amount, the automatic operation of the bending processing can be continued. This makes it possible not only to correct the change in the bending angle due to secular change without stopping the automatic operation, but also to improve productivity and quality.

It should be noted that in step S100 described above, if it is determined that the reset function for the pushing amount is not enabled (disabled (OFF)) (No in step S100), trial processing by the press brake 10 and the automatic robot 20 is performed (step S114), the processing state is inspected (step S115), and the process correction value is calculated without going through the setting of the trigger condition (step S101) as described above. Then, the process correction value is set by being input based on the input information (step S116), the operation of product processing is started (step S117), and the bending processing of the workpiece (step S118) is executed by the automatic operation or a manual operation.

After that, it is determined whether or not the end condition of the operation has been reached (step S119). If the end condition has not been reached (No in step S119), the bending processing (step S118) is continued. However, if the end condition is reached (Yes in step S119), the operation of the bending is ended and the processing of the bending method according to the present embodiment is ended.

It should be noted that in the above example, the correction values ΔUT1 to ΔUTn of the pushing amount are calculated after the displacement value ΔUT is calculated by comparing the reference value UT0 with the respective measured values UT1 to UTn. However, the correction values ΔUT1 to ΔUTn of the pushing amount may be calculated after the displacement value ΔUT is calculated by comparing the acquired measured value with the previously acquired measured value (or the reference value) every time the value of the reference position is acquired. Even when the pushing amount is corrected by using the correction values ΔUT1 to ΔUTn calculated in this manner, it is possible to continue the automatic operation of the bending processing as described above.

Further, in the above example, the acquisition condition or the resetting condition for resetting is that the workpiece is being loaded by the automatic robot 20, but these conditions may indicate that the workpiece is being unloaded by the automatic robot 20. If the acquisition of the reference position and the resetting of the pushing amount are performed while the workpiece is being loaded/unloaded in this manner, the automatic operation of the bending will not be affected. As a result, the correction can be performed without stopping the automatic operation in a more reliable manner.

Furthermore, in the above example, the pushing amount of the punch P (the tool) with respect to the die D to be used for the product processing is measured, but the present invention is not limited to this. A pushing amount of a tool other than the tool actually used (for example, a punch P with respect to a die D not used for the bending, which are attached to the upper tool holder 14 and the lower tool holder 15, respectively) may be measured. Even in this manner, it is possible to calculate the correction value of the secular change similar to the one described above. In other words, as long as the reference value UT0 and the measured value UTn are configured to be able to be acquired from the same tool as described above, the effect of the present embodiment can be exhibited regardless of whether or not the tool is to be used for bending.

### Second Embodiment

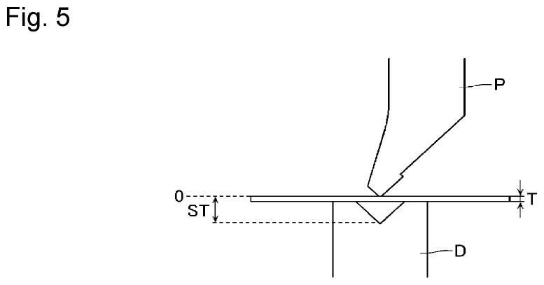

FIG. 5 is a diagram showing an outline of typical tools used for a press brake of a bending system according to a second embodiment of the present invention. It should be noted that in the following descriptions, the same or corresponding components as those of the first embodiment and its modified examples are designated by the same reference signs, and thus duplicated description will be omitted.

A bending method according to the second embodiment is different from the bending method according to the first embodiment in which the pushing amount is reset based on the reference position for each trigger condition, in that an original position of the punch P is reset based on a D-axis position for each trigger condition when the workpiece is interposed between the punch P and the die D, that is, when the workpiece is interposed between the tools, and thus the pushing amount is not changed.

In other words, in the present example, as shown in FIG. 5, the original position of the punch P is set as a position (a reference position (0 mm)) when the distal end of the punch P is brought into contact with a surface of the workpiece in a state in which the workpiece having a thickness T is placed on the die D, for example. A pushing amount ST represents a distance from this reference position to a groove bottom portion (a lower end portion) of a V-groove portion of the die D.

Then, in the bending method of the second embodiment, for example, the initial original position of the punch P is acquired and set at the start of the automatic operation of the bending processing, and thereafter, the original position of the punch P is acquired and reset for each predetermined trigger condition. In this manner, after setting the original position of the punch P for each trigger condition, the automatic operation of the bending processing is continued until the end of the operation. It should be noted that in this case, the original position of the punch P is set without changing the pushing amount ST (including the pushing amount). In the bending method of the second embodiment, the change in the bending angle due to secular change can also be corrected without stopping the operation. As a result, productivity and quality of the bent product can be improved.

Although some embodiments of the present invention have been described above, these embodiments are presented as examples and are not intended to limit the scope of the invention. These novel embodiments can be implemented in various other embodiments, and various omissions, replacements, and changes can be made without departing from the gist of the invention. These embodiments and modifications thereof are included in the scope and the gist of the invention, and are also included in the scope of the invention described in the claims and the equivalent scope thereof.

For example, in the first embodiment described above, the pushing amount is corrected by obtaining the correction value based on the reference position by using the tools including the punch P and the die D, but the correction is not limited to this. Additionally, the correction value may be obtained by calculating the result after calculating an amount of extension (change) of the support unit 13 itself when no load is applied, an amount of strain or the like due to an influence of a load based on extension or the like of the support unit 13 itself when a predetermined load is applied, or the like, which is measured by a strain gauge provided on the support unit 13 of the press brake 10.

### REFERENCE SIGNS LIST

1 Bending system
10 Press brake
11 Upper table
12 Lower table
13 Support unit
14 Upper tool holder
15 Lower tool holder
16 Drive mechanism
17 Position detection sensor
18 Bending load detection sensor
20 Automatic robot
30 Control device

1. A bending method for bending a workpiece by a bending system including a bending machine equipped with tools including a punch and a die provided so as to be relatively movable, a manipulator configured to position the workpiece with respect to the tools, and a control device configured to control the bending machine and the manipulator to perform bending, the bending method comprising
resetting, during an automatic operation of the bending of the workpiece by the bending machine, a pushing amount of the punch with respect to the die or an original position of the punch for each predetermined trigger condition.

2. The bending method according to claim 1, wherein the trigger condition is at least one of a room temperature, a time, and a number of processes.

3. The bending method according to claim 1, wherein the resetting is executed when a resetting condition is satisfied after the trigger condition is satisfied.

4. The bending method according to claim 3, wherein the resetting condition is that the workpiece is being loaded or unloaded by the manipulator.

5. The bending method according to claim 1, further comprising setting ON/OFF of execution of the resetting by the control device.

6. The bending method according to claim 1, wherein the pushing amount is reset in the resetting based on a tool original position on a D-axis when a predetermined load is applied to the tools.

7. The bending method according to claim 6, further comprising calculating a secular change amount of the tool original position as a correction value for the pushing amount, wherein
the pushing amount is corrected by using the calculated correction value during the automatic operation to bend the workpiece.

8. The bending method according to claim 1, wherein the original position of the punch is reset in the resetting based on a D-axis position when the workpiece is interposed between the tools.

9. A bending system comprising a bending machine equipped with tools including a punch and a die provided so as to be relatively movable, a manipulator configured to position a workpiece with respect to the tools, and a control device configured to control the bending machine and the manipulator to perform bending, wherein
the control device resets, during an automatic operation of the bending of the workpiece by the bending machine, a pushing amount of the punch with respect to the die or an original position of the punch for each predetermined trigger condition to perform the bending.

10. The bending system according to claim 9, wherein the trigger condition is at least one of a room temperature, a time, and a number of processes.

11. The bending system according to claim 9, wherein the pushing amount or the original position of the punch is reset when a resetting condition is satisfied after the trigger condition is satisfied.

12. The bending system according to claim 11, wherein the resetting condition is that the workpiece is being loaded or unloaded by the manipulator.

13. The bending system according to claim 9, wherein the control device sets ON/OFF for resetting the pushing amount or the original position of the punch.

14. The bending system according to claim 9, wherein the pushing amount is reset based on a tool original position on a D-axis when a predetermined load is applied to the tools.

15. The bending system according to claim 14, wherein the control device:
calculates a secular change amount of the tool original position as a correction value for the pushing amount; and
corrects the pushing amount by using the calculated correction value during the automatic operation to bend the workpiece.

16. The bending system according to claim 9, wherein the original position of the punch is reset based on a D-axis position when the workpiece is interposed between the tools.
